(19) United States
(12) Patent Application Publication
(10) Pub. No.: US 2006/0041048 A1
(43) Pub. Date: Feb. 23, 2006

(54) Method for manufacturing polymer-silicate nanocomposite material

(76) Inventors: Kung-Hwa Wei, Hsinchu (TW); Ching-Mao Huang, Hsinchu (TW); Rocky Shih, Taichung City (TW)

Correspondence Address: CHARLES E. BAXLEY, ESQ., 90 JOHN STREET, THIRD FLOOR, NEW YORK, NY, 10038, US

(21) Appl. No.: 10/921,542

(22) Filed: Aug. 19, 2004

(51) Int. Cl. C08K 3/34; C08K 5/24

(52) U.S. Cl. 524/442; 524/261

(57) ABSTRACT

A method for manufacturing polymer-silicate nanocomposite material is used to produce the polymer-silicate nanocomposite material by combining organic silicate layer with polyol for carrying out an polymerization, while nanophase silicate layers are evenly distributed over the polyol, so that the polyurethane-material-formed products made by polyol will be provided with good engineering properties, such as low expansion coefficient, high heat resistance, low hygroscopic coefficient, low permeability and light transmission that has no effect on the high polymer material. And thus, the market competitiveness of the product is accordingly improved.

### BACKGROUND OF THE INVENTION

1. Field of the Invention

This invention relates to a method for manufacturing composite material, and more particularly to a method for manufacturing polymer-silicate nanocomposite material.

2. Description of the Prior Arts

Polyurethane is the so-called PU with high engineering properties, high wearing-resistance and high cell-compatibility, which is widely applicable. For example, it can be made into shoe pad or synthetic leather. Nanometer technology is a new technology of the 21^{st} century and which, in the inorganic and organic field, is emphasized on the homogeneity of the composite material in the molecular phase, so as to effectively improve the performances of the composite material on all aspects. However, during the forming process, it is very hard to improve the distribution of the organic silicate layer to the nanometer level since the manufacture of the PU is a very fast reaction.

The present invention has arisen to mitigate and/or obviate the afore-described disadvantages.

### SUMMARY OF THE INVENTION

The primary object of the present invention is to provide a method for manufacturing polymer-silicate nanocomposite material capable of improving the engineering properties of the PU formed by polyol and enabling the PU to have low expansion coefficient, high heat resistance, low hygroscopic coefficient, low permeability and light transmission which has no effect on the high polymer material.

A method for manufacturing polymer-silicate nanocomposite material is provided in accordance with the present invention, wherein organic silicate layer is initially added in polyol, and then polymer-silicate nanocomposite material can be obtained after heating and polymerization process.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a flow chart for showing a method of manufacturing polymer-silicate nanocomposite material in accordance with a first embodiment of the present invention;

FIG. 2 is an illustrative view for showing a first material preparation process and a second material preparation process in accordance with the first embodiment of the present invention;

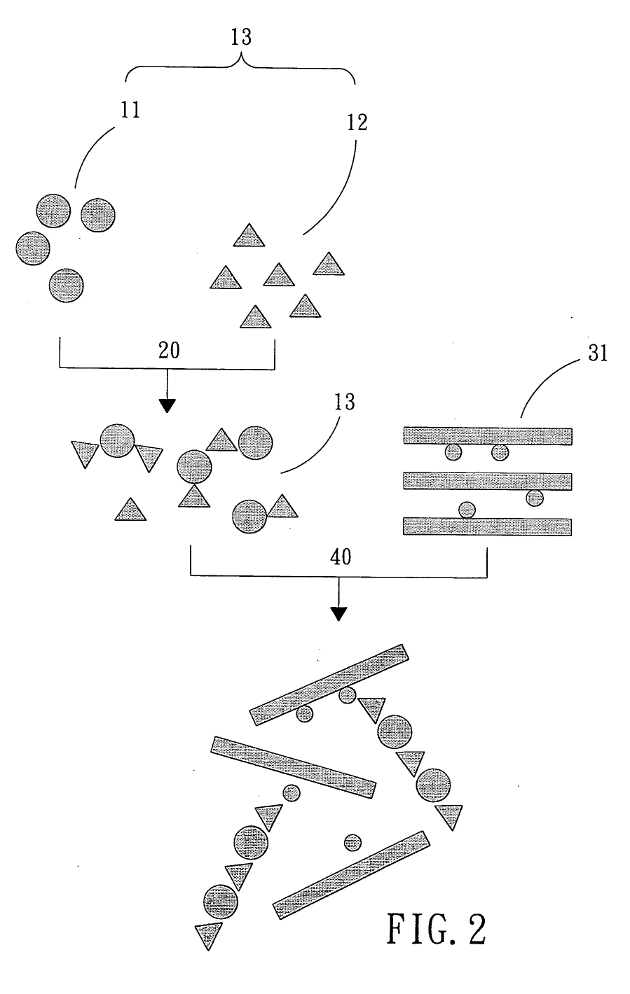

FIG. 3 is an illustrative view for showing a first polymerization reaction in accordance with the first embodiment of the present invention;

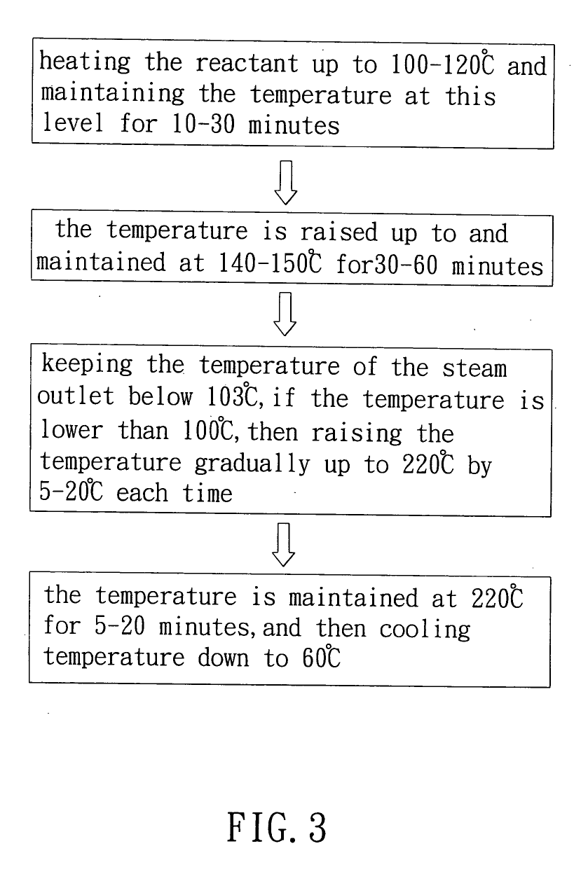

FIG. 4 is an illustrative view for showing a second polymerization reaction in accordance with the first embodiment of the present invention;

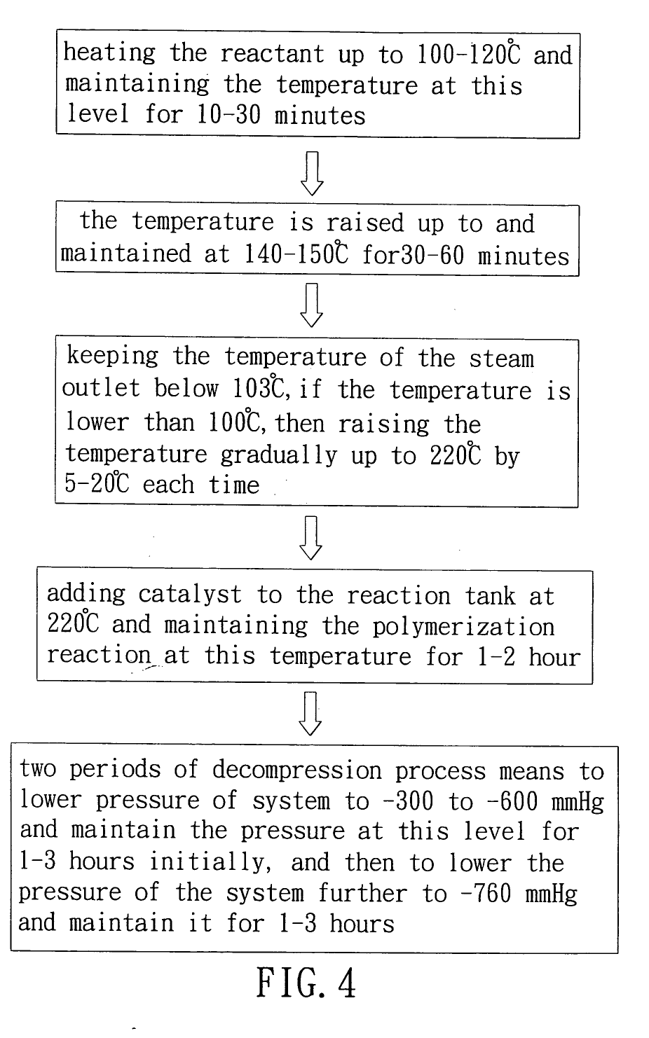

FIG. 5 shows silicate layers are dispersed on the polyol in accordance with a first embodiment of the present invention;

FIG. 6 shows the flow chart for manufacturing polymer-silicate nanocomposite material in accordance with a second embodiment of the present invention;

FIG. 7 is an illustrative view for showing a second material preparation process in accordance with the second embodiment of the present invention;

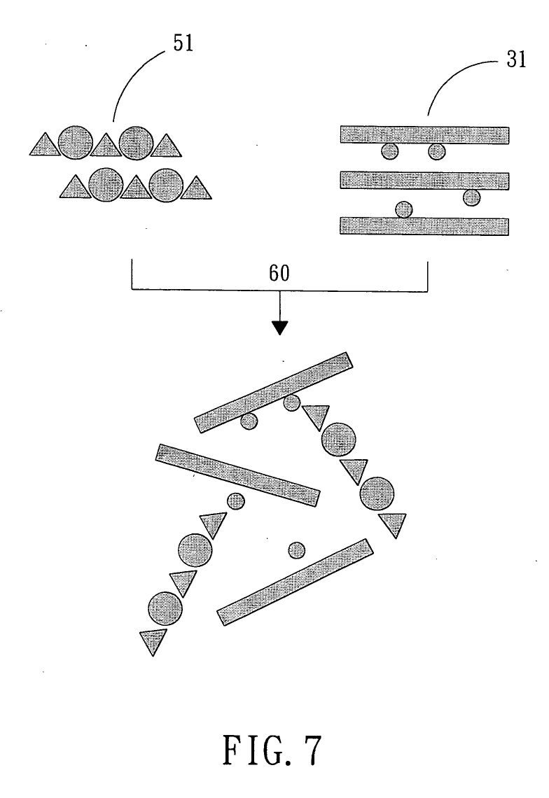

FIG. 8 shows the flow chart for manufacturing polymer-silicate nanocomposite material in accordance with a third embodiment of the present invention;

FIG. 9 shows a third material preparation process in accordance with the second embodiment of the present invention.

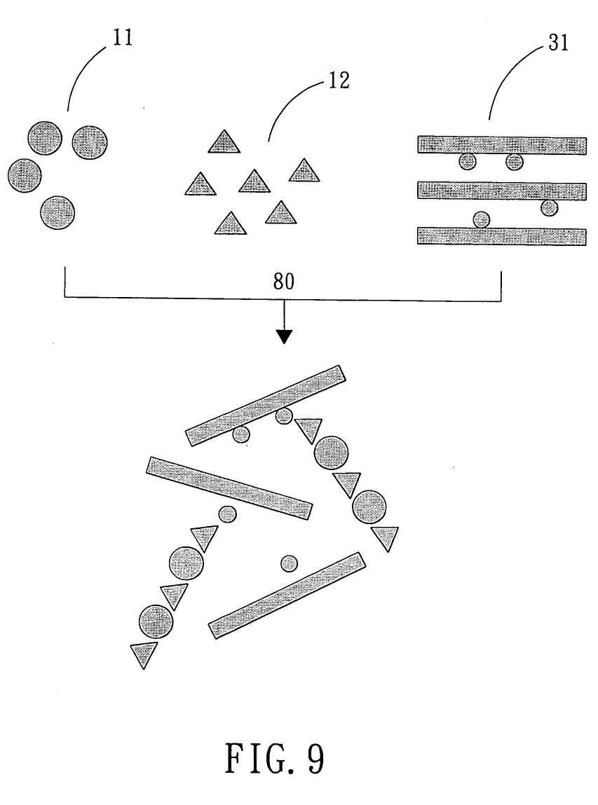

### DETAILED DESCRIPTION OF THE PREFERRED EMBODIMENTS

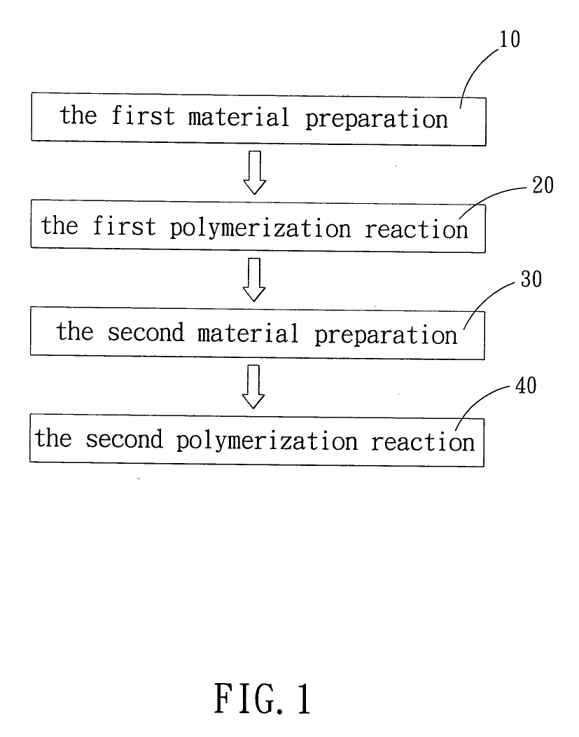

Referring to FIG. 1, which shows a method for manufacturing polymer-silicate nanocomposite material in accordance with a first embodiment of the present invention and generally including the steps as follows: A) first material preparation 10 B) first polymerization reaction 20 C) second material preparation 30 and D) second polymerization reaction 40.

A) first material preparation 10: choosing polyol as a first material 13 which is combined by dibasic acid 11 and dihydric alcohol 12 and the mole ratio of dibasic acid 11 to dihydric alcohol 12 is 1:1 or 1:1.5. The dibasic acid 11 can be oxalic acid, succinic acid . . . , Suberic acid. The dihydric alcohol 12 can be ethylene glycol . . . , octyl glycol.

B) first polymerization reaction 20: heating the first material 13 up to 100-120° C. and maintaining the temperature at this level for 10-30 minutes, and then the temperature is raised up to and maintained at 140-150° C. for 30-60 minutes so as to carry out the polymerization reaction. Next, keeping the temperature of the steam outlet below 103° C., if the temperature is lower than 100° C., then raising the temperature gradually up to 220° C. by 5-20° C. each time. After that, the temperature is maintained at 220° C. for 5-20 minutes, and then cooling temperature down to 60° C.

C) second material preparation 30: choosing 0.5-10 wt % reaction type silicate layer as a second material 31, the reaction type silicate layer refers to the end group of the silicate layer modifier containing extra NH₂, COOH or OH group. Combining the first material 13 with the second material 31 in reaction tank and agitating at temperature of 60° C. for one day, the reaction tank is a 1 liter flask with round bottom and four necks.

D) second polymerization reaction 40: heating the reactant in the reaction tank up to 100-120° C. and maintaining the temperature at this level for 10-30 minutes, and then the temperature is raised up to and maintained at 140-150° C. for 30-60 minutes so as to carry out the polymerization reaction, after that, keeping the temperature of the steam outlet below 103° C., if the temperature is lower than 100° C., then raising the temperature gradually up to 220° C. by 5-20° C. each time. And adding catalyst of tetra-butyl titanate (TBT) or tetrapropyl (TPT) to the reaction tank and maintaining the polymerization reaction at 220° C. for 1-2 hour, and then removing waste side-products with two periods of decompression process. Two periods of decompression process means to lower the pressure of the system to −300 to −600 mmHg and maintain the pressure at this level for 1-3 hours, and then to lower the pressure of the system further to −760 mmHg and maintain it for 1-3 hours. Finally, the polymer-silicate nanocomposite material can be obtained by cooling the reaction.

In this embodiment, the reactant material can be adipic acid (AA) and ethylene glycol (EG) and 1,4-butylene glycol (BG) which are arranged based on the mole ratio of 1:0.63:0.63 (the ratio of AA to EG is 1:1.26). Initially, temperature is raised up to and maintained at 100° C. for 15 minutes. And then, the temperature is further raised up to and maintained at 145° C. for 45 minutes. After that, keeping the temperature of the steam outlet below 103° C., if the temperature is lower than 100° C., then raising it up to 155° C., 165° C., 175° C., 185° C., 195° C., 205° C. till 220° C., respectively. After that, cooling the temperature down to 60° C. Choosing 3 wt % reaction type silicate layer as the second material 31, and agitating the first material 13 and the second material 31 synchronously in the reaction tank at temperature of 60° C, for one day. The reaction tank is a 1-liter round-bottom flask with four necks. After that, raising the temperature up to 100° C. again and maintaining it for 15 minutes, then the temperature is further raised up to and maintained at 145° C. for 45 minutes. After that, keeping the temperature of the steam outlet below 103° C., if the temperature is lower than 100° C., then raising it up to 155° C., 165° C., 175° C., 185° C., 195° C., 205° C. till 220° C., respectively. Adding catalyst of 0.3 g TBT 20 wt % in 1,4-BG and maintaining the polymerization reaction at 220° C. for 1 hour, then two periods of decompression process are carried out to lower the pressure of the system to −500 mmHg and maintain the pressure at this level for 1 hours initially, and then to lower the pressure of the system further to −760 mmHg and maintain it for 2 hours. Finally, grafting-Qn polymer-silicate nanocomposite material can be obtained by cooling the reaction.

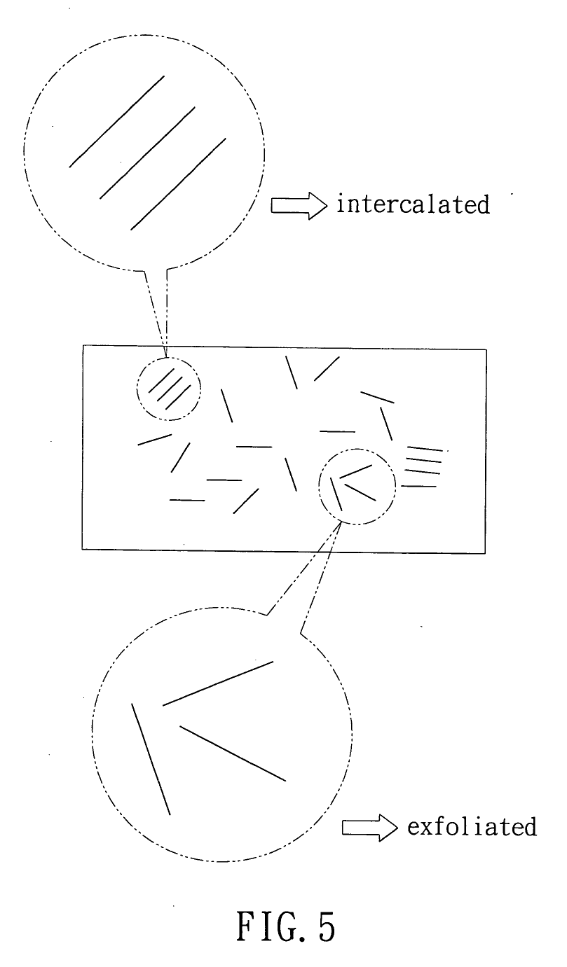

Through this way, the polymer-silicate nanocomposite material is produced by polymerizing the organic silicate layer (the second material 31) with the polyol (the first material 13). As shown in FIG. 5, nanophase silicate layers with a thickness of 07-1.2 nm and a diameter of 20-1000 nm are evenly dispersed on the polyol, and the spacing between layers is more than 3 nm, so that the polyurethane-material-formed products made by polyol will be provided with good engineering properties, such as low expansion coefficient, high heat resistance, low hygroscopic coefficient, low permeability and light transmission that has no effect on the high polymer material. And thus, the market competitiveness of the product is accordingly improved.

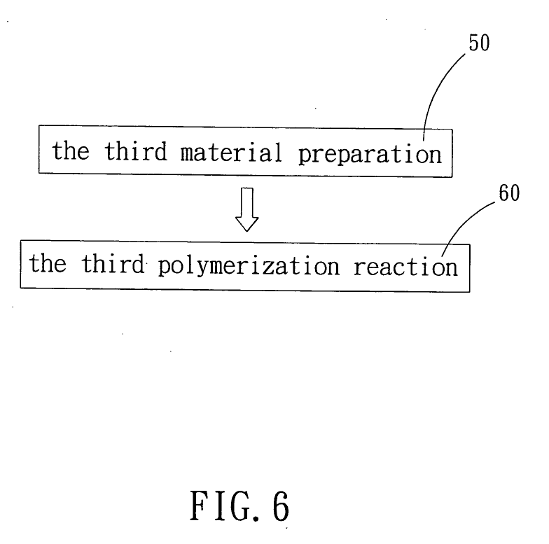

Referring to FIG. 6, which shows a method for manufacturing polymer-silicate nanocomposite material in accordance with a second embodiment of the present invention and generally including the steps as follows: A) third material preparation 50 and B) third polymerization reaction 60.

A) third material preparation 50: choosing high polymer having molecular weight 500-100,000 g/mole as third material 51 in the presence of 0.5-10 wt % reaction type organic silicate layer 31.

B) third polymerization reaction 60 in this embodiment is identical to the second polymerization reaction 20 in the first embodiment, thereby, further explanations on this matter are omitted.

In this embodiment, the high polymer with molecular weight of 2000 g/mole is agitated with the 3 wt % organic silicate layer 31 for a whole day, then the temperature is raised up to and maintained at 100° C. for 15 minutes. And the temperature is further raised up to and maintained at 145° C. for 45 minutes. Next, keeping the temperature of the steam outlet below 103° C., if the temperature is lower than 100° C., then raising the temperature up to 165° C., 185° C., 205° C. till at 220° C., and adding catalyst of 0.3 g TBT 20 wt % in 1,4-BG at 220° C. and maintaining the polymerization reaction at 220° C. for 1 hour, then two periods of decompression process are carried out to lower the pressure of the system to −500 mmHg and maintain the pressure at this level for 1 hours, and then to lower the pressure of the system further to −760 mmHg and maintain it for 1 hour. Finally, grafting-on polymer-silicate nanocomposite material can be obtained by cooling reaction down.

Through this way, the polymer-silicate nanocomposite material can be produced by polymerizing the organic silicate layer with the polyol, and the polymer-silicate nanocomposite material of this embodiment has the same merits as that of the first embodiment has.

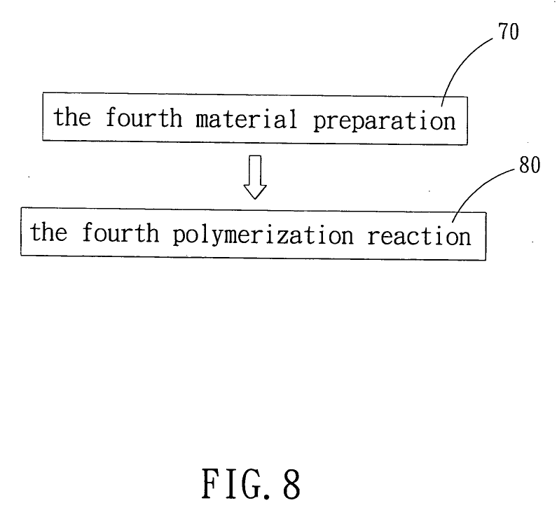

Referring to FIG. 8, which shows a method for manufacturing polymer-silicate nanocomposite material in accordance with a third embodiment of the present invention and generally including the steps as follows: A) fouth material preparation 70 and B) fouth polymerization reaction 80.

A) fouth material preparation 70: choosing the respective materials as raw materials which are used in the first material preparation 10 and the second material preparation 30 in the first embodiment (choosing polyol combined by dibasic acid and dihydric alcohol and the 0.5-10 wt % reaction type organic silicate layer as raw material, and the mole ratio of dibasic acid to dibasic alcohol is 1:1 or 1:1.5), after agitating for one day, polymerization reaction can be carried out.

B) fourth polymerization reaction 80 in this embodiment is identical to the second polymerization reaction 40 in the first embodiment, thereby, further explanations on this matter are omitted.

In this embodiment, the reactant material can be adipic acid (AA) and ethylene glycol (EG) and 1,4-butylene glycol (BG) which are arranged based on the mole ratio of 1:0.63:0.63 and in the presence of 3 wt % reaction type organic silicate layer (the ratio of AA to EG is 1:1.26). After one-day agitation, the temperature is raised up to and maintained at 100° C. for 15 minutes. And then, the temperature is further raised up to and maintained at 145° C. for 45 minutes. After that, keeping the temperature of the steam outlet below 103° C., if the temperature is lower than 100° C., then raising it up to 155° C., 165° C., 175° C., 185° C., 195° C., 205° C. till 220° C., respectively. After that, cooling the temperature down to 60° C. Choosing 3 wt % reaction type silicate layer as the second material 31, and agitating the first material 13 and the second material 31 synchronously in the reaction tank at temperature of 60° C. for one day. The reaction tank is a 1-liter round-bottom flask with four necks. After that, raising the temperature up to 100° C. again and maintaining it at this level for 15 minutes, then the temperature is further raised up to and maintained at 145° C. for 45 minutes. After that, keeping the temperature of the steam outlet below 103° C., if the temperature is lower than 100° C., then raising it up to 155° C., 165° C., 175° C., 185° C., 195° C., 205° C. till 220° C., respectively. Adding catalyst of 0.3 g TBT 20 wt % in 1,4-BG and maintaining the polymerization reaction at 220° C. for 1 hour, then two periods of decompression process are carried out to lower the pressure of the system to −500 mmHg and maintain the pressure at this level for 1 hours initially, and then to lower the pressure of the system further to −760 mmHg and maintain it for 2 hours. Finally, grafting-from polymer-silicate nanocomposite material can be obtained by cooling down the temperature.

While we have shown and described various embodiments in accordance with the present invention, it should be clear to those skilled in the art that further embodiments may be made without departing from the scope of the present invention.

What is claimed is:

1. A method for manufacturing polymer-silicate nanocomposite material, wherein organic silicate layer is initially added into polyol, then polymer-silicate nanocomposite material is obtained after heating and polymerization process.

2. The method for manufacturing polymer-silicate nanocomposite material as claimed in claim 1 comprises the following steps:
A) first material preparation: choosing polyol as a first material which is combined by dibasic acid and dihydric alcohol and mole ratio of dibasic acid to dihydric alcohol is 1:1 or 1:1.5;
B) first polymerization reaction: heating the first material up to 100-120° C. and maintaining temperature at this level for 10-30 minutes, and then the temperature is raised up to and maintained at 140-150° C. for 30-60 minutes, next, keeping temperature at steam outlet below 103° C., if the temperature is lower than 100° C., then raising the temperature gradually up to 220° C. by 5-20° C. each time, after that, the temperature is maintained at 220° C. for 5-20 minutes, and then cooling temperature down to 60° C.;
C) second material preparation: choosing 0.5-10 wt % reaction type silicate layer as a second material, combining the first material with the second material in reaction tank and agitating at temperature of 60° C. for one day;
D) second polymerization reaction: heating the reactant in the reaction tank up to 100-120° C. and maintaining the temperature at this level for 10-30 minutes, and then the temperature is raised up to and maintained at 140-150° C. for 30-60 minutes, after that, keeping the temperature of the steam outlet below 103° C., if the temperature is lower than 100° C., then raising the temperature gradually up to 220° C. by 5-20 C. each time, and adding catalyst to the reaction tank and maintaining the polymerization reaction at 220° C. for 1-2 hour, and then removing waste side-products with two periods of decompression process.

3. The method for manufacturing polymer-silicate nanocomposite material as claimed in claim 2, wherein the dibasic acid in the first material preparation can be oxalic acid, succinic acid . . . , suberic acid, and the dihydric alcohol can be ethylene glycol . . . , octyl glycol.

4. The method for manufacturing polymer-silicate nanocomposite material as claimed in claim 2, wherein the reaction type silicate layer used in the first polymerization reaction refers to end group of silicate layer modifier containing extra NH₂, COOH or OH group.

5. The method for manufacturing polymer-silicate nanocomposite material as claimed in claim 2, wherein the reaction tank used in the second material preparation is a 1-liter round-bottom flask with four necks.

6. The method for manufacturing polymer-silicate nanocomposite material as claimed in claim 2, wherein the catalyst used in the second polymerization reaction is tetra-butyl titanate.

7. The method for manufacturing polymer-silicate nanocomposite material as claimed in claim 2, wherein the catalyst used in the second polymerization reaction is tetrapropyl.

8. The method for manufacturing polymer-silicate nanocomposite material as claimed in claim 2, wherein the two periods of decompression process means to lower pressure of system to −300 to −600 mmHg and maintain the pressure at this level for 1-3 hours initially, and then to lower the pressure of the system further to −760 mmHg and maintain it for 1-3 hours, finally, the polymer-silicate nanocomposite material is obtained by cooling down the temperature.

9. The method for manufacturing polymer-silicate nanocomposite material as claimed in claim 1 comprises the following steps:
A) third material preparation: choosing high polymer having molecular weight 500-100,000 g/mole as a third material in the presence of 0.5-10 wt % reaction type organic silicate layer;
B) third polymerization reaction: heating the reactant in the reaction tank up to 100-120° C. and maintaining the temperature at this level for 10-30 minutes, and then the temperature is raised up to and maintained at 140-150° C. for 30-60 minutes, after that, keeping the temperature of the steam outlet below 103° C., if the temperature is lower than 100° C., then raising the temperature gradually up to 220° C. by 5-20° C. each time, and adding catalyst to the reaction tank and maintaining the polymerization reaction at 220° C. for 1-2 hour, and then removing waste side-products with two periods of decompression process.

10. The method for manufacturing polymer-silicate nanocomposite material as claimed in claim 1 comprises the following steps:
A) fourth material preparation: choosing polyol combined by dibasic acid and dihydric alcohol and the 0.5-10 wt % reaction type organic silicate layer as raw material, and mole ratio of dibasic acid to dihydric alcohol is 1:1 or 1:1.5), after one-day agitation, polymerization reaction is to be carried out.
B) fourth polymerization reaction: putting the third material in the reaction tank and heating it up to 100-120° C. and maintaining the temperature at this level for 10-30 minutes, and then the temperature is raised up to and maintained at 140-150° C. for 30-60 minutes, after that, keeping the temperature of the steam outlet below 103° C., if the temperature is lower than 100° C., then raising the temperature gradually up to 220° C. by 5-20° C. each time, and adding catalyst to the reaction tank and maintaining the polymerization reaction at 220° C. for 1-2 hour, and then removing waste side-products with two periods of decompression process.
